(19) United States
(12) Patent Application Publication
(10) Pub. No.: US 2010/0250994 A1
(43) Pub. Date: Sep. 30, 2010

(54) DATA PATTERN DETECTING CIRCUIT AND OUTPUT DRIVER INCLUDING THE SAME

(76) Inventors: Chang-Kun Park, Gyeonggi-do (KR); Yong-Ju Kim, Gyeonggi-do (KR); Kyung-Whan Kim, Gyeonggi-do (KR); Sung-Woo Han, Gyeonggi-do (KR); Jae-Il Kim, Gyeonggi-do (KR); Hee-Woong Song, Gyeonggi-do (KR); Ic-Su Oh, Gyeonggi-do (KR); Hyung-Soo Kim, Gyeonggi-do (KR); Tae-Jin Hwang, Gyeonggi-do (KR); Hae-Rang Choi, Gyeonggi-do (KR); Ji-Wang Lee, Gyeonggi-do (KR); Jae-Min Jang, Gyeonggi-do (KR)

Correspondence Address: IP & T Law Firm PLC, 7700 Little River Turnpike, Suite 207, Annandale, VA, 22003, US

(21) Appl. No.: 12/495,332

(22) Filed: Jun. 30, 2009

(30) Foreign Application Priority Data
Mar. 31, 2009 (KR) 10-2009-0027575

(51) Int. Cl. G06F 1/12

(52) U.S. Cl. 713/400

(57) ABSTRACT

Disclosed is an output driver capable of solving problems that occur when outputting the same data successively by using a data pattern detecting circuit. The data pattern detecting circuit includes a first data storage unit configured to receive data of a first line and store the received data until a next data is inputted through the first line, a second data storage unit configured to receive data of a second line and store the received data until a next data is inputted through the second line, and a detection signal output unit configured to activate a pattern detection signal when data stored in the first data storage unit and data stored in the second data storage unit have the same logic level.

### CROSS-REFERENCE TO RELATED APPLICATIONS

The present application claims priority of Korean patent application number 10-2009-0027575, filed on Mar. 31, 2009, the disclosure of which is incorporated herein by reference in its entirety.

### BACKGROUND OF THE INVENTION

The present invention relates to an output driver of a semiconductor chip for outputting data to the outside of a semiconductor chip, and more particularly, to an output driver capable of solving problems that occur when outputting the same data successively.

A semiconductor device often includes a data input buffer, a core region, and an output driver. The data input buffer and the output driver are used to receive and output data from/to the outside of the semiconductor device. In the semiconductor device, the data are processed in the core region.

While external data transferred to a semiconductor device is a sufficiently comparatively large signal, data processed and outputted by a core region is a comparatively small signal. Thus, an output driver needs to have the driving strength to pull up or pull down an external load according to data transferred from the core region. Hence, an output driver for driving data to the outside of a semiconductor device is provided at a data output pad.

FIG. 1 is a circuit diagram of a conventional output driver. Referring to FIG. 1, the conventional output driver includes a multiplexing unit 110, a pre-driving unit 120, and a main driving unit 130.

The multiplexing unit 110 alternately outputs a rising data RD0 and a falling data FD0 which are inputted in synchronization with a rising clock RCLK and a falling clock FCLK, respectively. The rising clock RCLK has an opposite phase to the falling clock FCLK.

The pre-driving unit 120 outputs a pre-data PRE_DATA in response to an output data of the multiplexing unit 110. The pre-driving unit 120 amplifies a data signal so that the amplified data signal can drive the main driving unit 130. That is, the strength of the pre-data PRE_DATA is stronger than that of the output data of the multiplexing unit 110.

The main driving unit 130 drives a data output pad DQ in response to the pre-data PRE_DATA and outputs data to the outside of a semiconductor device. Since the data outputted from the main driving unit 130 is outputted to the outside, the power of the data, i.e., output signals, has to be greater than that of internal signals. Therefore, a pull-up transistor 131 and a pull-down transistor 132 used in the main driving unit 130 are designed to be comparatively large in size.

An output signal of the main driving unit 130 is limited by various specifications, one of which is a slew rate. When a slew rate of the output signal is comparatively low, a receiving unit of an external chip receiving the output signal of the main driving unit 130 cannot accurately detect the output signal. On the other hand, when the slew rate is too high, problems such as electromagnetic interference (EMI) and reflected waves are caused.

Although it is shown in FIG. 1 that one multiplexing unit 110 and one pre-driving unit 120 control both the pull-up transistor 131 and the pull-down transistor 132 of the main driving unit 130, the multiplexing unit 110 and the pre-driving unit 120 may also be provided to each of the pull-transistor 131 and the pull-down transistor 132 for controlling them individually.

FIG. 2 illustrates waveform diagrams of output signals of the main driving unit 130 and the pre-driving unit 120.

To be specific, the wave diagram (A) shows the output signal of the main driving unit 130. As can be seen from FIG. 2(A), an actual output waveform of the main driving unit 130, indicated by a solid line, has linear rising and falling slopes, as opposed to an ideal rectangular-shaped signal waveform indicated by a dotted line.

The waveform diagram (B) shows the pre-data PRE_DATA outputted from the pre-driving unit 120. As the pre-data PRE_DATA has the waveform diagram (B), the output signal of the main driving unit 130 may have the waveform diagram (A). That is, the output waveform of the pre-data PRE-DATA is generated so that a slew rate of the output waveform of the main driving unit 130 may meet a specification. Herein, since the pre-data PRE_DATA is inverted by the main driving unit 130, the output waveform of the main driving unit 130 has an opposite phase to the waveform of the pre-data PRE_DATA.

FIG. 3 illustrates waveform diagrams of the output signals of the pre-driving unit 120 and the main driving unit 130 where a concern may be raised.

Generally, since the sizes of the transistors 131 and 132 of the main driving unit 130 are comparatively large, parasitic capacitance components are comparatively large. Therefore, a certain time constant is defined by a channel resistance component of the transistor constituting the pre-driving unit 120 and a parasitic capacitance component of the transistors 131 and 132 constituting the main driving unit 130.

While the output signal PRE_DATA of the pre-driving unit 120 in a steady state can maintain an ideal waveform as shown in FIG. 2 (B), the output signal PRE_DATA of the pre-driving unit 120 has a waveform shown in the top of FIG. 3 before reaching the steady state. Consequently, it distorts the output signal of the main driving unit 130 as shown in the bottom of FIG. 3. While the output signal of the main driving unit 130 has an ideal rectangular-shaped waveform, it can be seen that the data outputted from the main driving unit 130 have inconsistent widths.

While the phenomenon occurs at periods where data toggle back and forth repeatedly as in the data pattern “010101 . . . ,” which is shown in FIG. 3, it can be seen from FIG. 4 that the same situation as that shown in FIG. 3 also occurs at periods where data do not toggle back and forth repeatedly as in the pattern “001.”

### SUMMARY OF THE INVENTION

Embodiments of the present invention are directed to providing a data pattern detecting circuit for detecting a pattern of data to be outputted, and an output driver capable of preventing the data to be outputted from being distorted by controlling its driving strength according to a detection result of the data pattern detecting circuit.

In accordance with an aspect of the present invention, there is provided a data pattern detecting circuit, which includes a first data storage unit configured to receive data of a first line and store the received data until a next data is inputted through the first line, a second data storage unit configured to receive data of a second line and store the received data until a next data is inputted through the second line, and a detection signal output unit configured to activate a pattern detection signal when data stored in the first data storage unit and data stored in the second data storage unit have the same logic level.

The first line may be a data line through which a rising data synchronized with a rising clock is transferred, and the second line may be a data line through which a falling data synchronized with a falling clock is transferred.

In accordance with another aspect of the present invention, there is provided an output driver, which includes a multiplexing unit configured to sequentially output a rising data and a falling data that are inputted in synchronization with a rising clock and a falling clock, respectively; a data pattern detection unit configured to store the rising data and the falling data for a predetermined time, and to activate a pattern detection signal when the stored rising and falling data have the same logic level; a first driving unit configured to drive a pre-data in response to an output data of the multiplexing unit; a second driving unit configured to drive the pre-data in response to the output data of the multiplexing unit and the pattern detection signal; and a main driving unit configured to output data to the outside of a semiconductor device in response to the pre-data.

In accordance with further aspect of the present invention, there is provided an output driver, which includes a multiplexing unit configured to sequentially output a rising data and a falling data that are inputted in synchronization with a rising clock and a falling clock, respectively, a data pattern detection unit configured to store the rising data and the falling data for a predetermined time, and to activate a pattern detection signal when the stored rising and falling data have the same logic level, a pre-driving unit configured to drive a pre-data in response to an output data of the multiplexing unit, a first main driving unit configured to drive a data output pad in response to the pre-data, and a second main driving unit configured to drive the data output pad in response to the pre-data and the pattern detection signal.

The data pattern detection unit may include a first data storage unit configured to receive the rising data and store the received rising data until a next rising data is inputted, a second data storage unit configured to receive the falling data and store the received falling data until a next falling data is inputted, and a detection signal output unit configured to activate a high pattern detection signal when data stored in the first data storage unit and data stored in the second data storage unit are logic high data, and to activate a low pattern detection signal when the data stored in the first data storage unit and the data stored in the second data storage unit are logic low data.

### BRIEF DESCRIPTION OF THE DRAWINGS

FIG. 1 is a circuit diagram of a conventional output driver.

FIG. 2 illustrates waveform diagrams of an output signal of a main driver unit 130 and an output signal of a pre-driver unit 120.

FIG. 3 illustrates waveform diagrams of the output signal of the pre-driver unit 120 and the output signal of the main driver unit 130 where a concern is raised.

FIG. 4 is a waveform diagram illustrating a concern in FIG. 3 in case where data does not constantly toggle back and forth.

FIG. 5 is a circuit diagram of a data pattern detecting circuit in accordance with an embodiment of the present invention.

FIG. 6 is a circuit diagram of an output driver in accordance with a first embodiment of the present invention.

FIG. 7 is a timing diagram illustrating the overall operation of the output driver of FIG. 6.

FIG. 8 is circuit diagram of an output driver in accordance with a second embodiment of the present invention.

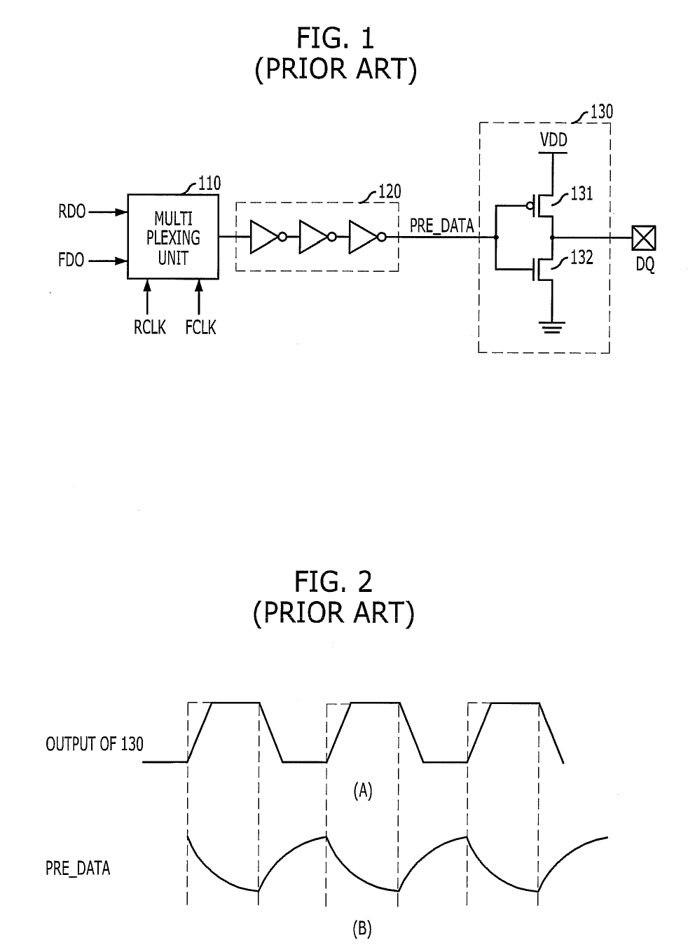

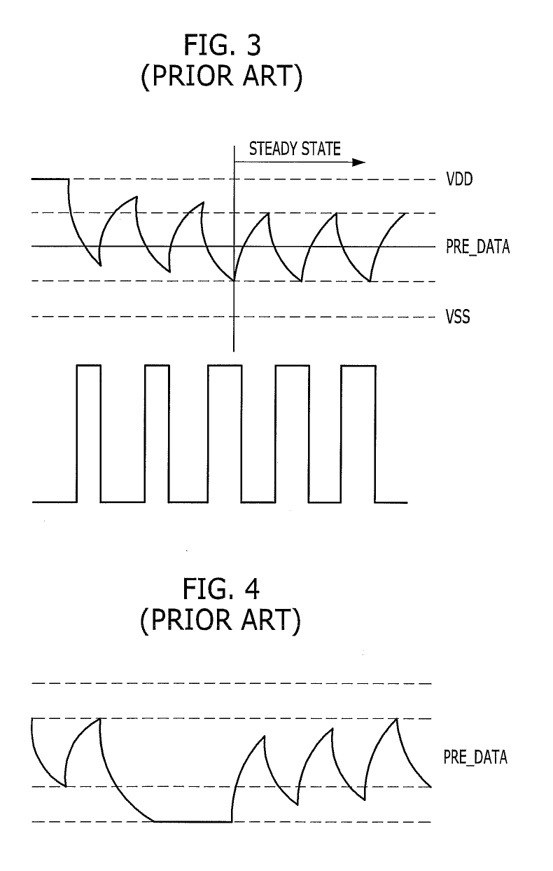

### DESCRIPTION OF SPECIFIC EMBODIMENTS

Other objects and advantages of the present invention can be understood by the following description, and become apparent with reference to the embodiments of the present invention.

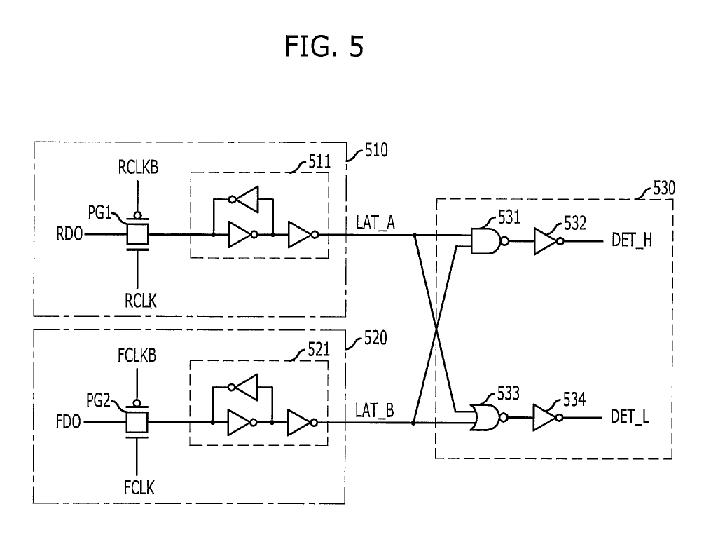

FIG. 5 is a circuit diagram of a data pattern detecting circuit in accordance with an embodiment of the present invention. Referring to FIG. 5, the data pattern detecting circuit includes a first data storage unit 510, a second data storage unit 520, and a detection signal output unit 530. The first data storage unit 510 receives data of a first line and stores the received data until a next data is inputted through the first line. The second data storage unit 520 receives data of a second line and stores the received data until a next data is inputted through the second line. The detection signal output unit 530 activates a pattern detection signal DET_H or DET_L when data LAT_A stored in the first data storage unit 510 and data LAT_B stored in the second data storage unit 520 have the same logic level.

The data of the first line and the data of the second line are data that are serially aligned and are to be sequentially outputted to the outside of the semiconductor device. Examples of the data include a rising data RD0 and a falling data FD0 that are synchronized with a rising clock and a falling clock, respectively. Hereafter, it is assumed that the data of the first line and the data of the second line are the rising data RD0 and the falling data FD0, respectively.

The first data storage unit 510 includes a first pass gate PG1 and a first latch 511. The first pass gate PG1 is turned on/off in synchronization with a rising clock RCLK to receive the rising data RD0, and the first latch 511 is connected to an output terminal of the first pass gate PG1. Accordingly, the first data storage unit 510 receives a rising data RD0_0 and stores the received rising data RD0_0 until a next rising data RD0_1 (data after one clock) is inputted.

The second data storage unit 520 includes a second pass gate PG2 and a second latch 521. The second pass gate PG2 is turned on/off in synchronization with a falling clock FCLK to receive the rising data FD0, and the second latch 521 is connected to an output terminal of the second pass gate PG2. Accordingly, the second data storage unit 520 receives a falling data FD0_0 and stores the received falling data FD0_0 until a next falling data FD0_1 (data after one clock) is inputted.

The detection signal output unit 530 activates the pattern detection signal DET_H or DET_L when the data LAT_A stored in the first data storage unit 510 is identical to the data LAT_B stored in the second data storage unit 520. The detection signal output unit 530 activates a high pattern detection signal DET_H when both the data stored in the first data storage unit 510 and the data stored in the second data storage unit 520 are at a high level, and activates a low pattern detection signal DET_L when both the data stored in the first data storage unit 510 and the data stored in the second data storage unit 520 are at a low level. The detection signal output unit 530 includes a NAND gate 531 and a NOR gate 533. The NAND gate 531 performs a logical combination of the data LAT_A stored in the first latch 511 and the data LAT_B stored in the second latch 521 to output the high pattern detection signal DET_H. The NOR gate 533 performs a logical combination of the data LAT_A stored in the first latch 511 and the data LAT_B stored in the second latch 521 to output the low pattern detection signal DET_L.

Upon operation of the data pattern detecting circuit, the rising data RD is stored in the first data storage unit 510, and the falling data FD is stored in the second data storage unit 520. The rising data RD0 and the falling data FD0 are to be alternately outputted to the outside of the semiconductor device. Therefore, the stored rising data LAT_A and the stored falling data LAT_B having the same logic level means that data having the same logic level will be outputted successively. The case where both the stored rising data LAT_A and the stored falling data LAT_B have a high level means that a high data pattern, e.g., ‘11’, will be outputted. Hence, in this case, the detection signal output unit 530 activates the high pattern detection signal DET_H to a high level. Also, the case where both the stored rising data LAT_A and the stored falling data LAT_B have low level means that a low data pattern, e.g., ‘00’, will be outputted. Hence, in this case, the detection signal output unit 530 activates the low pattern detection signal DET_H to a low level.

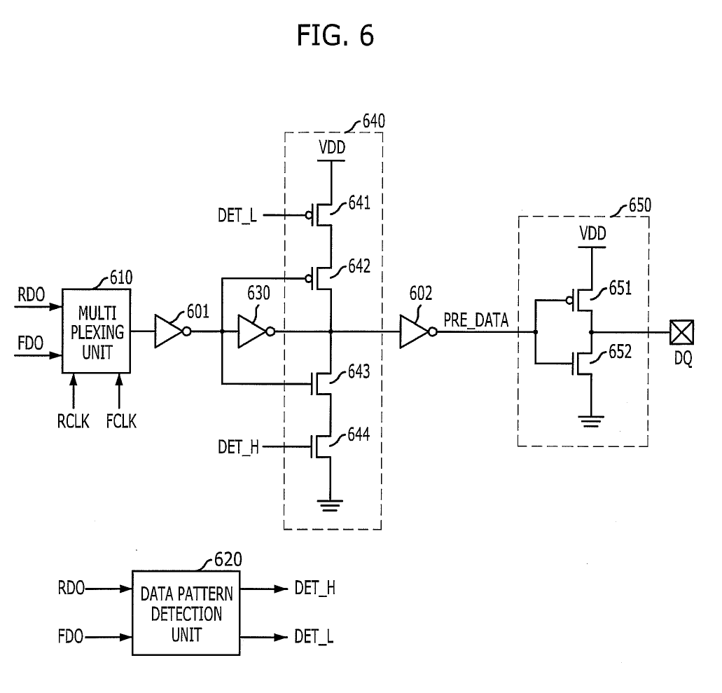

FIG. 6 is a circuit diagram of an output driver in accordance with a first embodiment of the present invention. Referring to FIG. 6, the output driver in accordance with the first embodiment of the present invention includes a multiplexing unit 610, a data pattern detection unit 620, a first driving unit 630, a second driving unit 640, and a main driving unit 650. The multiplexing unit 610 sequentially outputs a rising data RD0 and a falling data FD0 that are inputted in synchronization with a rising clock RCLK and a falling clock FCLK, respectively. The data pattern detection unit 620 stores the rising data RD0 and the falling data FD0 for a certain time, and activates a pattern detection signal DET_H or DET_L when the stored data RD0 and FD0 have the same logic level. The first driving unit 630 drives a pre-data PRE_DATA in response to an output data of the multiplexing unit 610. The second driving unit 640 drives the pre-data PRE_DATA in response to the output data of the multiplexing unit 610 and the pattern detection signals DET_H and DET_L. The main driving unit 650 outputs data to the outside of the semiconductor device in response to the pre-data PRE_DATA.

The multiplexing unit 610 alternately outputs the rising data RD0 and the falling data FD0. The multiplexing unit 610 outputs the rising data RD0 in a period where the rising clock RCLK is at a high level, and outputs the falling data FD0 in a period where the falling clock FCLK is at a high level.

That is, the multiplexing unit 610 serializes the rising data RD0 and the falling data FD0 inputted in parallel.

The data pattern detection unit 620 stores the rising data RD0 and the falling data FD0 in response to each clock, and activates the pattern detection signals DET_H or DET_L when the stored rising data RD0 is identical to the stored falling data FD0. The data pattern detection unit 620 activates a high pattern detection signal DET_H when both the stored rising data RD0 and the stored falling data FD0 are high data, and activates a low pattern detection signal DET_L when both the stored rising data RD0 and the stored falling data FD0 are low data. Since the constitution and operation of the data pattern detection unit 620 have been described in detail with reference to FIG. 5, their further description is unnecessary and thus omitted.

The first driving unit 630 drives the pre-data PRE_DATA in response to the output data of the multiplexing unit 610. Since an inverter 601 is provided between the multiplexing unit 610 and the first driving unit 630, the output of the first driving unit 630 is identical to the output of the multiplexing unit 610. Moreover, since an inverter 602 inverts the output of the first driving unit 630 and the output of the inverter 602 is the pre-data PRE_DATA, the output of the first driving unit 630 has a phase opposite to that of the pre-data PRE_DATA.

The second driving unit 640 drives the pre-data PRE_DATA in response to the output data of the multiplexing unit 610 and the pattern detection signals DET_H and DET_L. Like the first driving unit 630, the second driving unit 640 drives the pre-data PRE_DATA in response to the output data of the multiplexing unit 610. However, the second driving unit 640 operates only when the pattern detection signals DET_H and DET_L are in an activated state. The second driving unit 640 drives the pre-data PRE_DATA to a high level only when the high pattern detection signal DET_H is activated to a high level and the output data of the multiplexing unit 610 is in a low state. On the other hand, the second driving unit 640 drives the pre-data PRE_DATA to a low level only when the low pattern detection signal DET_L is activated to a low level and the output data of the multiplexing unit 610 is in a high state. That is, based on the data outputted from the main driving unit 650, the second driving unit 640 is driven when the data is driven to a low state in case where the data are outputted in high-high-low pattern. On the other hand, in case where data are outputted in low-low-high pattern, the second driving unit 640 is driven when the data is driven to a high state.

The main driving unit 650 outputs the data through a data output pad DQ to the outside of the semiconductor device in response to the pre-data PRE_DATA. The main driver unit 650 is implemented with comparatively large-sized transistors 651 and 652 because it has to drive the data to the outside.

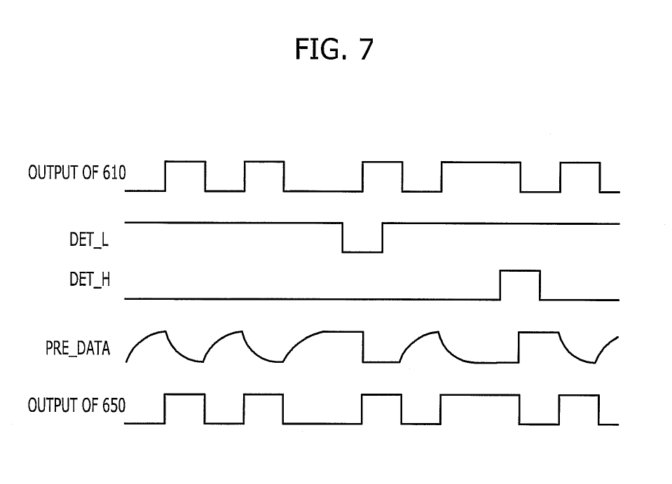

FIG. 7 is a timing diagram illustrating the overall operation of the output driver of FIG. 6. Referring to FIG. 7, the low pattern detection signal DET_L is activated to a low level in a period where the output data of the multiplexing unit 610 has a low-low-high pattern. When the low pattern detection signal DET_L is in an activated state, the second driving unit 640 as well as the first driving unit 630 drives the pre-data PRE_DATA. Therefore, the high-to-low transition of the pre-data PRE_DATA occurs strongly (The pre-data PRE_DATA has an opposite phase to the output data of the multiplexing unit 610). Consequently, the output data of the main driving unit 650 has a normal data window without distortion.

The high pattern detection signal DET_H is activated to a high level in a period where the output data of the multiplexing unit 610 has a high-high-low pattern. When the high pattern detection signal DET_H is in an activated state, the second driving unit 640 as well as the first driving unit 630 drives the pre-data PRE_DATA. Therefore, the low-to-high transition of the pre-data PRE_DATA occurs strongly. Consequently, the output data of the main driving unit 650 has a normal data window without distortion.

Such an arrangement is different from the prior art in which, for example, the waveform of the output data of the main driving unit 130 is distorted when the data are outputted in a high-high-low pattern or a low-low-high pattern.

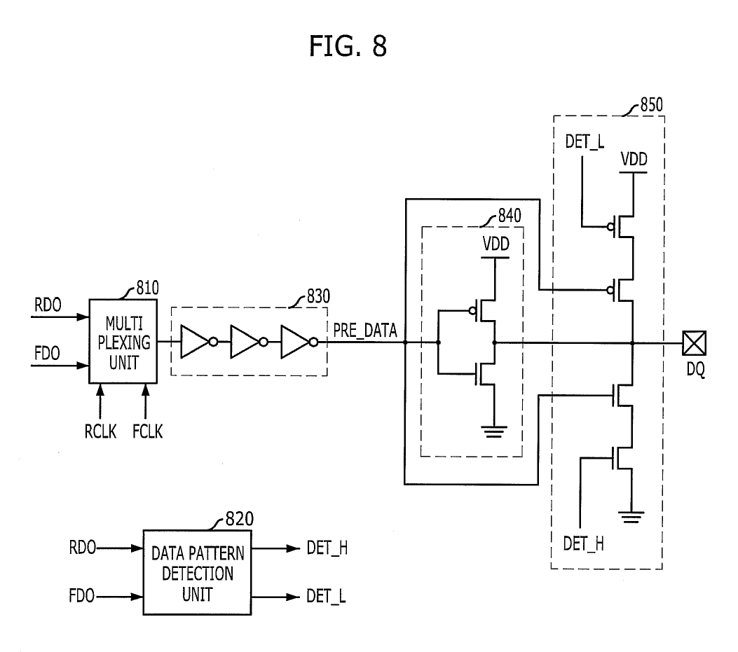

FIG. 8 is circuit diagram of an output driver in accordance with a second embodiment of the present invention. Referring to FIG. 8, the output driver in accordance with the second embodiment of the present invention includes a multiplexing unit 810, a data pattern detection unit 820, a pre-driving unit 830, a first main driving unit 840, and a second main driving unit 850. The multiplexing unit 810 sequentially outputs a rising data RD0 and a falling data FD0 that are inputted in synchronization with a rising clock RCLK and a falling clock FCLK, respectively. The data pattern detection unit 820 stores the rising data RD0 and the falling data FD0 for a certain time, and activates a pattern detection signal DET_H or DET_L when the stored data RD0 and FD0 have the same logic level. The pre-driving unit 830 drives a pre-data PRE_DATA in response to an output data of the multiplexing unit 810. The first main driving unit 840 drives a data output pad DQ in response to the pre-data PRE_DATA. The second main driving unit 850 drives the data output pad DQ in response to the pre-data PRE_DATA and the pattern detection signals DET_H and DET_L.

The above-mentioned output driver of FIG. 6 in accordance with the first embodiment of the present invention prevents the data distortion by controlling the strength of driving the pre-data PRE_DATA when the pattern detection signals DET_H and DET_L are in the activated state. However, the output driver of FIG. 8 in accordance with the second embodiment of the present invention directly controls the driving strength of the main driving unit for the data output pad, instead of controlling the strength driving the pre-data PRE_DATA.

The first main driving unit 840 drives the data output pad DQ in response to the pre-data PRE_DATA. The second main driving unit 850 drives the data output pad DQ in response to the pre-data PRE_DATA only when the pattern detection signal DET_H or DET_L is in the activated state. Since both the first main driving unit 840 and the second main driving unit 850 operate when the pattern detection signals DET_H and DET_L are in the activated state, a total driving strength of the main driving units 840 and 850 increases, thereby preventing data distortion.

Since the output driver of FIG. 8 in accordance with the second embodiment of the present invention operates in the same manner as the output driver of FIG. 6 in accordance with the first embodiment of the present invention, except that the former controls the driving strength of the main driving units 840 and 850, its further description is unnecessary and is thus omitted.

In accordance with the embodiments of the present invention, the data pattern detecting circuit can detect whether data to be successively outputted are identical to each other, and activate the pattern detection signal when the same data are successively outputted. Therefore, it is possible to identify characteristics of the data to be outputted.

In accordance with the embodiments of the present invention, the output driver increases its own driving strength by using the data pattern detecting circuit when different data is outputted after the same successive data. Therefore, distortion in the output data of the output driver is prevented/reduced regardless of the pattern of the output data.

While the present invention has been described with respect to the specific embodiments, it will be apparent to those skilled in the art that various changes and modifications may be made without departing from the spirit and scope of the invention as defined in the following claims.

What is claimed is:

1. A data pattern detecting circuit, comprising:
a first data storage unit configured to receive data of a first line and store the received data until a next data is inputted through the first line;
a second data storage unit configured to receive data of a second line and store the received data until a next data is inputted through the second line; and
a detection signal output unit configured to activate a pattern detection signal when data stored in the first data storage unit and data stored in the second data storage unit have the same logic level.

2. The data pattern detecting circuit of claim 1, wherein the detection signal output unit is configured to activate a high pattern detection signal when the data stored in the first data storage unit and the data stored in the second data storage unit are logic high data, and activate a low pattern detection signal when the data stored in the first data storage unit and the data stored in the second data storage unit are logic low data.

3. The data pattern detecting circuit of claim 2, wherein the first line is a data line through which a rising data synchronized with a rising clock is transferred, and the second line is a data line through which a falling data synchronized with a falling clock is transferred.

4. The data pattern detecting circuit of claim 3, wherein the first data storage unit includes:
a first pass gate configured to be turned on/off in response to the rising clock and receive the data of the first line; and
a first latch connected to an output terminal of the first pass gate.

5. The data pattern detecting circuit of claim 4, wherein the second data storage unit includes:
a second pass gate configured to be turned on/off in response to the falling clock and receive the data of the second line; and
a second latch connected to an output terminal of the second pass gate.

6. The data pattern detecting circuit of claim 5, wherein the detection signal output unit includes:
a NAND gate configured to perform a logical combination of data stored in the first latch and data stored in the second latch to output the high pattern detection signal; and
a NOR gate configured to perform a logical combination of the data stored in the first latch and the data stored in the second latch to output the low pattern detection signal.

7. An output driver, comprising:
a multiplexing unit configured to sequentially output a rising data and a falling data that are inputted in synchronization with a rising clock and a falling clock, respectively;
a data pattern detection unit configured to store the rising data and the falling data for a predetermined time, and to activate a pattern detection signal when the stored rising and falling data have the same logic level;
a first driving unit configured to drive a pre-data in response to an output data of the multiplexing unit;
a second driving unit configured to drive the pre-data in response to the output data of the multiplexing unit and the pattern detection signal; and
a main driving unit configured to output data to the outside of a semiconductor device in response to the pre-data.

8. The output driver of claim 7, wherein the data pattern detection unit includes:
a first data storage unit configured to receive the rising data and store the received rising data until a next rising data is inputted;
a second data storage unit configured to receive the falling data and store the received falling data until a next falling data is inputted; and
a detection signal output unit configured to activate a high pattern detection signal when data stored in the first data storage unit and data stored in the second data storage unit are logic high data, and to activate a low pattern detection signal when the data stored in the first data storage unit and the data stored in the second data storage unit are logic low data.

9. The output driver of claim 8, wherein the second driving unit is driven when the high pattern detection signal is activated and the output data of the multiplexing unit is a logic low data, or when the low pattern detection signal is activated and the output data of the multiplexer unit is a logic high data.

10. The output driver of claim 8, wherein the first data storage unit includes:
a first pass gate configured to be turned on/off in response to the rising clock and receive the rising data; and
a first latch connected to an output terminal of the first pass gate.

11. The output driver of claim 10, wherein the second data storage unit includes:
a second pass gate configured to be turned on/off in response to the falling clock and receive the falling data; and
a second latch connected to an output terminal of the second pass gate.

12. The output driver of claim 11, wherein the detection signal output unit includes:
a NAND gate configured to perform a logical combination of data stored in the first latch and data stored in the second latch to output the high pattern detection signal; and
a NOR gate configured to perform a logical combination of the data stored in the first latch and the data stored in the second latch to output the low pattern detection signal.

13. An output driver, comprising:
a multiplexing unit configured to sequentially output a rising data and a falling data that are inputted in synchronization with a rising clock and a falling clock, respectively;
a data pattern detection unit configured to store the rising data and the falling data for a predetermined time, and to activate a pattern detection signal when the stored rising and falling data have the same logic level;
a pre-driving unit configured to drive a pre-data in response to an output data of the multiplexing unit;
a first main driving unit configured to drive a data output pad in response to the pre-data; and
a second main driving unit configured to drive the data output pad in response to the pre-data and the pattern detection signal.

14. The output driver of claim 13, wherein the data pattern detection unit includes:
a first data storage unit configured to receive the rising data and store the received rising data until a next rising data is inputted;
a second data storage unit configured to receive the falling data and store the received falling data until a next falling data is inputted; and
a detection signal output unit configured to activate a high pattern detection signal when data stored in the first data storage unit and data stored in the second data storage unit are logic high data, and to activate a low pattern detection signal when the data stored in the first data storage unit and the data stored in the second data storage unit are logic low data.

15. The output driver of claim 14, wherein the second main driving unit is configured to drive the data output pad when the low pattern detection signal or the high pattern detection signal is activated.

16. The output driver of claim 13, wherein the first data storage unit includes:
a first pass gate configured to be turned on/off in response to the rising clock and receive the rising data; and
a first latch connected to an output terminal of the first pass gate.

17. The output driver of claim 16, wherein the second data storage unit includes:
a second pass gate configured to be turned on/off in response to the falling clock and receive the falling data; and
a second latch connected to an output terminal of the second pass gate.

18. The output driver of claim 17, wherein the detection signal output unit includes:
a NAND gate configured to perform a logical combination of data stored in the first latch and data stored in the second latch to output the high pattern detection signal; and
a NOR gate configured to perform a logical combination of the data stored in the first latch and the data stored in the second latch to output the low pattern detection signal.
